(19) United States
(12) Patent Application Publication
(10) Pub. No.: US 2011/0227752 A1
(43) Pub. Date: Sep. 22, 2011

(54) Plate Position Display Vibration Machine

(76) Inventor: Morris Aboody, Toronto (CA)

(21) Appl. No.: 12/726,745

(22) Filed: Mar. 18, 2010

(51) Int. Cl. G09F 9/33

(52) U.S. Cl. 340/815.45

(57) ABSTRACT

The Plate Position Display Vibration Machine is a Whole Body Vibration Machine which represents visually the oscillating plate position as a ratio of the actual position.

A Whole Body Vibration Machine consists of a vibrating base, with handle supports, which ressembles a treadmill, but not as large. Vibration Machines are now widely available for sale. An example of a Vibration Machine is in FIG. 1.

One type of machine is the Oscillating (side-alternating or pivotal) machine. The plate on an Oscillating machine “see-saws” from side to side as shown in FIG. 2. Each side goes up and down. How far up and down the plate moves at the outer edge is the amplitude (usually about 10 mm). The amplitude is shown by the arrows in FIG. 2.

The purpose of this invention is to invent a vibration machine that shows the position of the plate edge visually, for example by a moving straight line simulating the platform (as in FIG. 3) or a moving linear set of LEDs (FIG. 4). The plate position, whether at the extreme top or bottom on each side or points in between, is shown visually. Since the actual plate position may be too fast to show, the display will be a ratio of the actual position.

### DRAWINGS

FIG. 1 shows a Vibration Machine

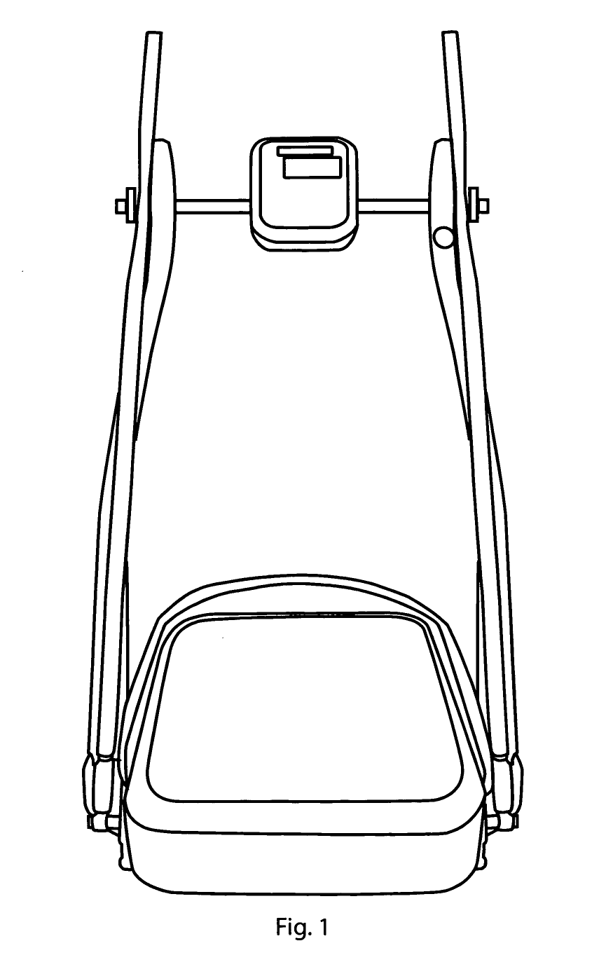

FIG. 2 shows an oscillating plate

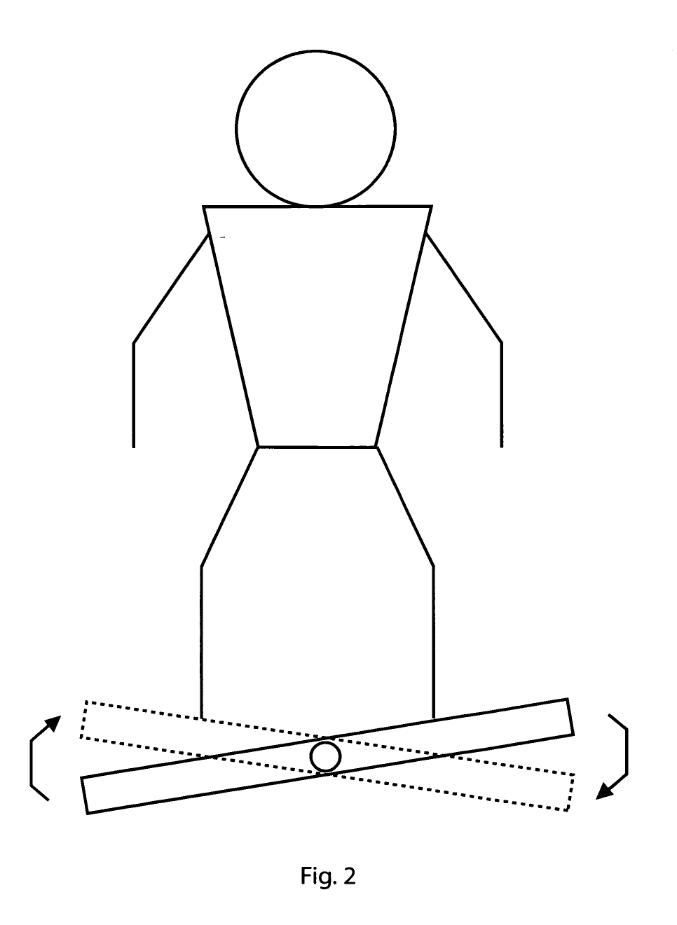

FIG. 3 shows a plate simulation at several positions

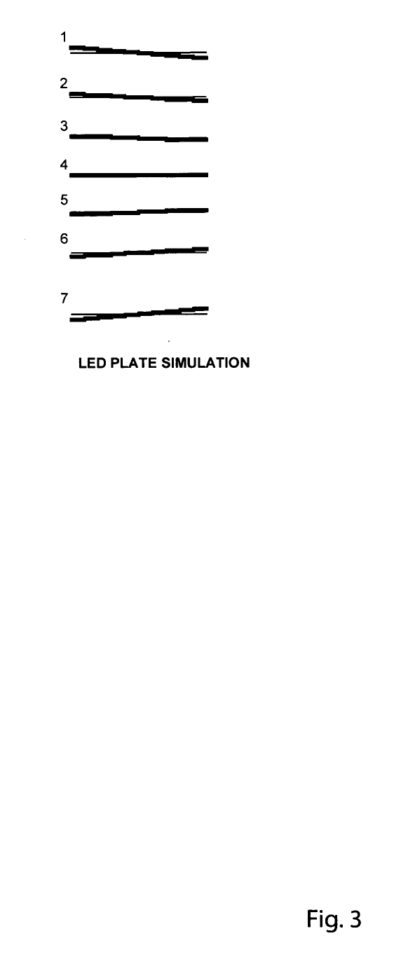

FIG. 4 shows a moving set of LEDs simulating the plate left edge position

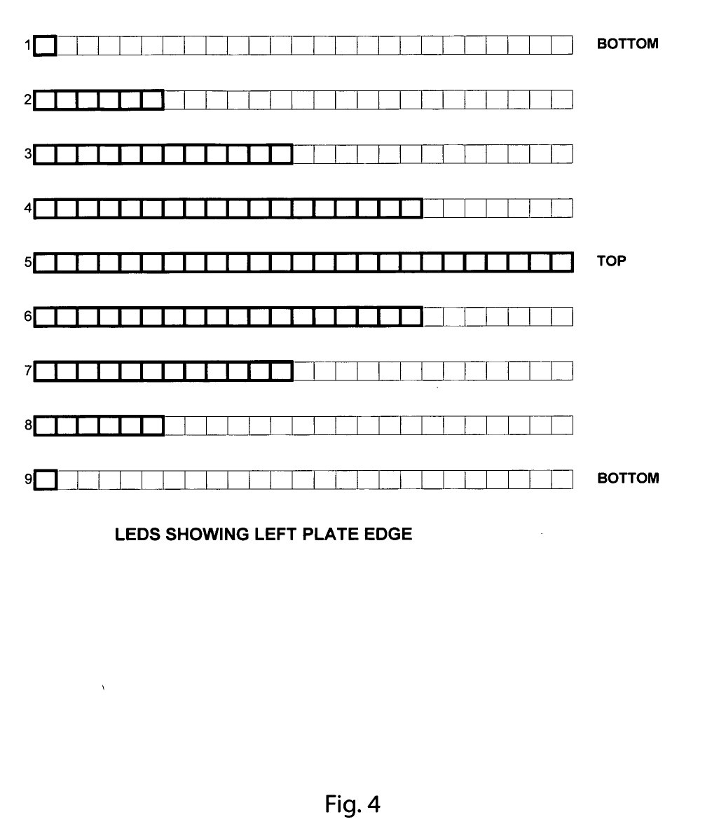

1. We claim a Vibration Machine with visual display of the oscillating plate position, as shown and described.
